(19) United States
(12) Patent Application Publication
(10) Pub. No.: US 2010/0239703 A1
(43) Pub. Date: Sep. 23, 2010

(54) Casting tool

(76) Inventor: Ivo Herzog, Gerlingen (DE)

Correspondence Address: FLYNN THIEL BOUTELL & TANIS, P.C., 2026 RAMBLING ROAD, KALAMAZOO, MI, 49008-1631, US

(21) Appl. No.: 12/590,228

(22) Filed: Nov. 4, 2009

(30) Foreign Application Priority Data
Mar. 17, 2009 (DE) 10 2009 014 566.4

(51) Int. Cl. B29C 39/36

(52) U.S. Cl. 425/443

(57) ABSTRACT

The invention relates to a casting tool for the production of castings (20), in particular a sand casting tool, comprising a mold element (12) having a mold recess (14b), which at least partly defines the contour of the casting (20) to be produced, an ejector holding device (40) which is movable in the direction of a Z-axis relatively to the mold element (12) and is disposed on the that side of the mold element (12) which faces away from the mold recess (14b), and at least one ejector rod (50), which is attached to the ejector holding device (40) and is capable of being inserted through an access bore (30) in the mold element (12), oriented in the direction of the Z-axis, so as to protrude into the mold recess (14b) for the purpose of pushing out the finished casting (20) from the mold recess (14b), wherein the attachment of the ejecting rod (50) to the ejector holding device (40) is effected in such a manner that the ejector rod (50) has restricted freedom of movement relatively to the ejector holding device (40) in the direction of an X-axis and/or in the direction of a Y-axis, which axes are orthogonal to each other and to the Z-axis,

According to the invention, for the purpose of attaching the ejector rod (50) to the ejector holding device (40) the ejector rod (50) passes through a connection bore (44) in the ejector holding device (40) and at that region of the ejector rod (50) which is disposed on the freely accessible side of the ejector holding device (40) remote from the mold element (12) (40b), a first securing element (52, 54) is releasably connected to the ejector rod (50) to prevent the ejector rod (50) from being pulled out of the ejector holding device (40) toward the mold element (12).

### TECHNICAL FIELD AND PRIOR ART

The invention relates to a casting tool for the production of castings, which casting tool can be configured, in particular, as a sand casting tool.

A generic casting tool comprises a mold element with a mold recess, which at least partly defines the contour of the casting to be produced. A generic casting tool further comprises an ejector holding device, which is displaceable in the direction of a Z-axis relatively to the mold element and which is disposed on the side of the mold facing away from the mold recess. At least one ejecting rod is attached to said ejector holding device, which rod can be inserted into an access bore in the mold element as far as the mold recess in the mold element in alignment with the Z-axis, in order to push the finished casting out of the mold recess.

Generic casting tools are known in the prior art. As a general rule these prior generic casting tools comprise two mold elements having a mold recess in each case, which mold recesses are aligned relatively to each other in such a way that, in the closed condition of the mold formed by the two mold halves, they form a common mold cavity that has the shape of the casting to be produced.

In order to remove the finished casting produced in this mold from one of the mold elements, provision is made for preferably a plurality of ejecting rods to be inserted through bores in the mold element as far as the mold recess in order to push the finished casting out of the mold recess. To this end, the ejecting rods are attached onto a common ejector holding device, which can be moved in the direction of the Z-axis in order to push all of the ejecting rods simultaneously into the mold recess, thereby ensuring that the casting is subjected to uniform forces as it is detached from the mold element.

The ejecting rods in generic casting tools are in turn attached to the ejector holding device in such a way that they are displaceable to a limited degree relatively to the ejector holding device in the direction of an X-axis and/or in the direction of a Y-axis, which are orthogonally aligned relative to each other and to the Z-axis. Due to this limited freedom of movement of the ejecting rods transversely to their longitudinal direction in the direction of the Z-axis, precise alignment in the direction of the X-axis and in the direction of the Y-axis is not necessary for mounting the ejecting rods on the ejector holding device.

The attachment of the ejecting rods to the ejector holding device is achieved with the casting tools known in the prior art as follows: On a base plate of the ejector holding device guided relatively to the mold in the direction of the Z-axis, a first metal sheet is provided on the side facing the mold element, which metal sheet has a hole for to each ejection rod. In which hole a flange nut is inserted. The flange of this flange nut has a non-circular configuration, so that the flange nut can be turned only to a limited degree in the hole in the first metal sheet and furthermore, owing to the size difference between the flange and the hole, the flange nut is translatively displaceable to a limited degree within the hole. A second metal sheet is positioned on the first metal sheet, which second metal sheet also has a hole for each ejecting rod, which holes in the second metal sheet are smaller than the holes in the first metal sheet so that the flange nut will not fit through the hole in the second metal sheet and therefore cannot be removed from the ejector holding device. The ejecting rod is screwed into this flange nut. The ejecting rod is made immovable on the ejector holding device as regards the Z-axis by means of a counter nut, which is also screwed onto the ejecting rod.

This configuration of the securing means poses a considerable problem with respect to the replacement of an ejecting rod of the casting tool. Since generic casting tools often have as many as several hundred ejecting rods, it is often very difficult to release an ejecting rod from the ejector holding device by loosening its associated counter nut, as these counter nuts are located in a zone between the ejector holding device and the mold element. Due to the fact that as many as several hundred other ejecting rods are located in this zone, it is often necessary to remove a large number of such other ejecting rods simply to gain access to the ejecting rod to be replaced.

### OBJECT OF THE INVENTION AND ITS ACHIEVEMENT

It is thus an object of the invention to provide a casting tool of a generic nature which is improved so as to facilitate the detachment of the ejecting rod from the ejector holding device. A further object is to provide a cost-effective means of attaching the ejecting rod to the ejector holding device.

According to the invention, this object is achieved in that for the purpose of attaching the ejecting rod to the ejector holding device, the ejecting rod is fed through a connection bore in the ejector holding device and a first securing element is detachably connected to the ejecting rod on a segment of the ejecting rod located on the freely accessible side of the ejector holding device facing away from the mold element, thus preventing the ejecting rod from being pulled toward the mold element and out of the ejector holding device.

In the configuration of the invention, provision is made for feeding the ejecting rod through the ejector holding device, which ejector holding device is to be understood as meaning that device by means of which the force applied for the purpose of removing a casting from the mold recess is transferred to the ejecting rod. For the purpose of releasing the casting from the mold element, the ejector holding device can in turn be configured to be indirectly or directly subjected to a force applied by a casting machine in which the casting tool of the invention is being used. With a casting tool having a plurality of ejecting rods assigned to the mold element, the ejector holding device serves as a means for the attachment and simultaneous displacement of said plurality of ejecting rods. Preference is given to a configuration of the ejector holding device as an ejector plate extending primarily in the direction of the X-axis and in the direction of the Y-axis.

On the freely accessible side of the ejector holding device facing away from the mold element, there is provided a first securing element, which is detachably connected to the ejection rod so that the ejection rod cannot be pulled toward the mold element and out of the ejection holding device when said first securing element is mounted. Free accessibility to the side facing away from the mold element is achievable by not providing any other elements that are simultaneously displaceable with the ejector holding device on this side that would block access to the first securing element. However, for the purposes of the invention, free accessibility is considered as achieved even if the securing means are blocked by non-load-bearing and therefore easily detachable components, such as a protective plate, such non-load-bearing components being characterized in that they are removable without negatively affecting the attachment of the ejecting rods to the ejector holding device.

The disposition of the first securing element on the freely accessible side of the ejector holding device facing away from the mold offers the advantage that by loosening said first securing element a condition is achieved in which the ejecting rod is detachable from the ejector holding device without requiring any manipulation in the space between the ejector holding device and the mold element. After loosening the securing element, the ejecting rod can be pulled directly out of the ejector holding device, preferably from within the mold recess. However, the means of attaching the ejecting rods to the ejector holding device can also be configured such that after loosening of the first securing element, the ejecting rod is removed by unscrewing it from a second securing element.

In a development of the invention, the first securing element has a first nut on that side of the ejector holding device which faces away from the mold element, which nut is screwed onto a thread provided on the end of the ejecting rod remote from the mold. Attachment by means of a male thread provided on the ejecting rod and a corresponding first nut as the first securing element constitutes a particularly simple and economical solution.

In a development of the invention, provision is made for a second securing element connected to the ejecting rod on the side of the ejector holding device which faces the mold element, which second securing element prevents the ejecting rod from being pulled away from the mold element and out of the ejector holding device. This second securing element in conjunction with the first securing element completely secures the ejecting rod in the direction of the Z-axis.

The second securing element is preferably also configured as a nut and screwed onto the ejecting rod. Different threads with optionally different thread diameters or a common thread can thus be provided for the first nut and for the second nut. The configuration of the second securing element as a nut is also advantageous because of the simplicity and cost effectiveness of such a solution.

It is particularly advantageous when the first nut is countered against a stop element on the ejecting rod or against the second securing element, in which case the first nut in its countered condition is disposed such that no clamping effect is exerted on the ejector holding device in the direction of the Z-axis. According to this development, the securing elements are thus countered against each other, the securing elements and the ejector holding device being configured in such a way that no clamping effect in the direction of the Z-axis is achieved by such countering. Countering is a simple option for securing the securing elements particularly when configured as nuts. Since the securing elements are countered against each other rather than against the ejector holding device itself and are spaced sufficiently far apart from each other, the displaceability of the ejecting rod in the direction of the X-axis and in the direction of the Y-axis relatively to the ejector holding device is not affected due to the absence of a clamping effect.

The invention further relates to a generic casting tool, particularly a development of the casting tool described above, in which provision is made for a locking part mounted on the ejecting rod in a torque-proof manner, wherein the locking part is disposed in a designated accommodating area in a fixed position relative to the ejector holding device and interacting with the locking part in such a way that a complete turn of the locking part about the Z-axis is blocked, and the accommodating area is configured as a depression formed in the ejector holding device.

The locking part can thus be formed by one of the types of securing elements described above. It is particularly advantageous when the second securing element has a second nut on which the locking part is provided, because after loosening the first securing element, particularly the first nut, it is then possible to detach the ejecting rod from the second nut on that side of the ejector holding device which faces away from the mold element by unscrewing the ejecting rod, while the second nut is prevented from simultaneously turning during unscrewing due to the locking part in the accommodating area. The novelty of this configuration resides particularly in said accommodating area, the shape of which is adapted to that of the locking part in such a way that rotation of the locking part is blocked. According to the invention, this accommodating area is configured as a depression formed in the ejector holding device itself. In this manner it is possible to achieve locking without any other components, such as a metal sheet with holes mounted on the base plate. The depression can be formed in the ejector holding device, more preferably an ejector plate, by milling.

In a development of the invention, the securing bore has a diameter that is adapted to the ejecting rod and/or to a securing element such that the ejecting rod is displaceable by at least 2 mm in the direction of the X-axis and/or in the direction of the Y-axis. The displaceability of the ejecting rod in the securing bore is ensured by configuring the securing bore in this manner. If the securing elements are configured such that they surround the part of the ejecting rod residing in the securing bore, said securing elements must be adapted to the securing bore in the manner described.

In a development of the invention, the ejecting rod has a cross-section which is uniform or which tapers toward the distal end, at least in a region disposed in the access bore and within the mold recess during the intended ejection from the mold element. Undesired catching of the ejecting rod on the mold element as the ejecting rod is pulled back into the mold element after ejection of the casting is thus avoided.

Particular preference is given to a casting tool which has a plurality of ejecting rods attached to a common ejector holding device, in which case the number of ejecting rods is preferably greater than 10, more preferably greater than 50, and most preferably greater than 100.

### BRIEF DESCRIPTION OF THE DRAWINGS

Other aspects and advantages of this invention are discernable from the claims and also from the following description of a preferred exemplary embodiment of the invention, which is explained with reference to the figures, in which:

FIGS. 1a to 1c show a casting tool of the invention and illustrate the intended use of the ejecting rods provided on this tool,

FIGS. 2a and 2b show an ejector plate of the casting tool illustrated in FIGS. 1a to 1c and also an enlarged view of a detail of this ejector plate with an ejecting rod to be mounted thereon in an exploded view, and

FIGS. 3a and 3b are enlarged cross-sections of a detail of the tool illustrated in FIGS. 1a to 1c.

### DETAILED DESCRIPTION OF THE EXEMPLARY EMBODIMENT

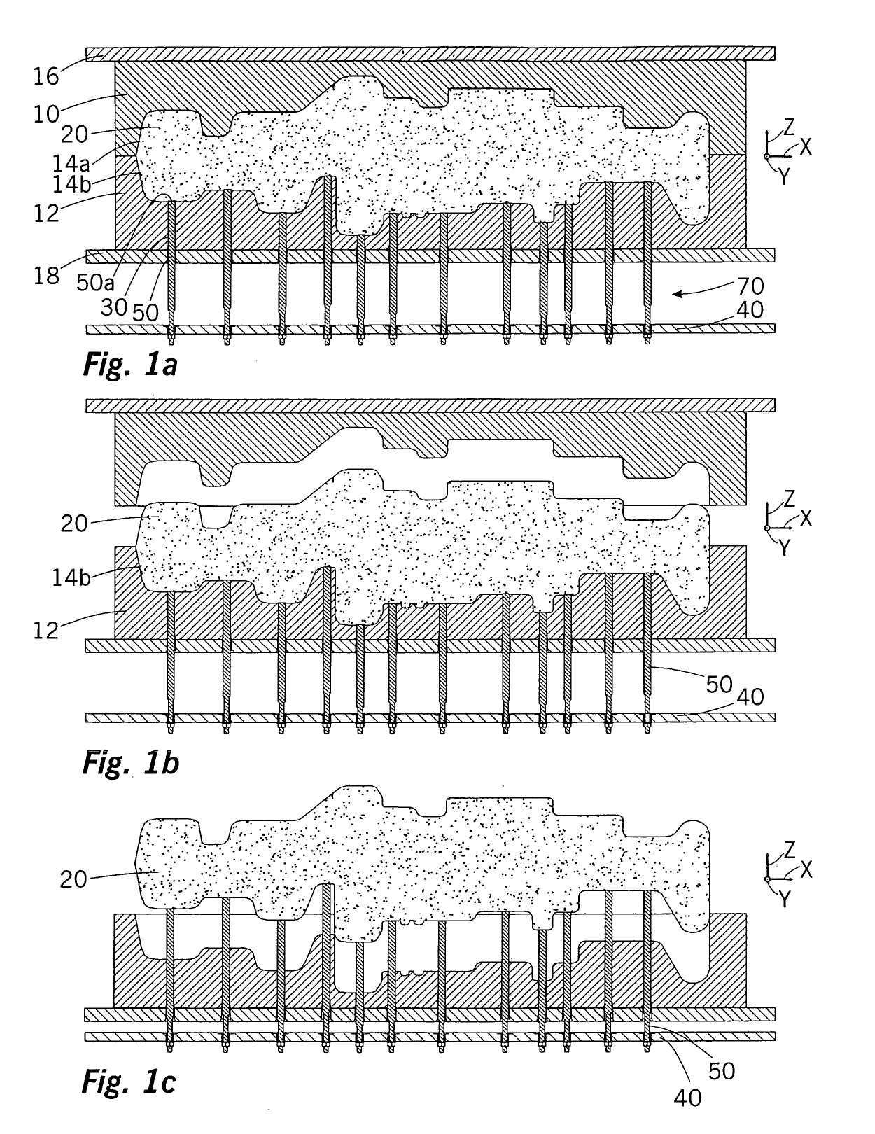

A casting tool of the invention, the operation of which will be explained below, is depicted in FIGS. 1a to 1c.

The casting tool of the invention shown in FIGS. 1a to 1c has a top mold element 10 and a bottom mold element 12. In both of these mold elements 10, 12 there are provided mold recesses 14a, 14b, which mold recesses 14a, 14b, in the closed condition illustrated in FIG. 1A, together define the shape of the casting 20 to be produced. The mold elements 10, 12 are in each case mounted on base plates 16, 18, which are displaceable relatively to each other in the direction of a Z-axis in a manner not shown in any greater detail. This displaceability can be achieved by, say, actuators of a casting machine in which the illustrated tool is being used.

In the bottom mold element 12 and in the associated base plate 18 there are provided access bores 30, which extend in the direction of the Z-axis and which are configured as through bores 30. These access bores 30 extend from the underside of the base plate 18 as far as the mold recess 14b. An ejecting rod 50 is inserted into each of these access bores 30, all ejecting rods 50 being connected to a common ejector plate 40 in a manner described below, so that they are jointly displaceable with said ejector plate 40 in the direction of the Z-axis. The ejecting rods 50 vary in length such that the distal end faces 50a of the ejecting rods 50 are each aligned flush with the contour of the mold recess 14b.

The condition shown in FIG. 1a represents the condition after filling the joint mold cavity 14a, 14b with sand and after gas treatment of the sand for the purpose of producing a dimensionally stable casting 20. The individual components of the casting tool required for introducing the sand and for the gas treatment of the introduced sand are not shown or explained in detail herein.

In order to remove the solidified casting 20 from the recesses 14a, 14b, the mold elements 10, 12 are first separated from each other via the base plates 16, 18. Means (not illustrated) can be provided to prevent the casting 20 from sticking to the top mold element 10.

The condition shown in FIG. 1b is achieved by separating the mold elements 10, 12 from each other. In this condition, the casting 20 is accessible from above, but still resides in the bottom mold element 12. In order to extract the same from this bottom mold element 12, the ejector plate 40 is then raised relatively to the bottom mold element 12 so that all of the ejecting rods 50 attached thereto slide simultaneously and to the same extent into the mold recess 14b and in doing so lift the casting 20 from the mold element 12.

The raised condition is shown in FIG. 1c. In this condition, the casting 20 can be easily extracted manually or by lifting it out with a rake, which is introduced for this purpose to a position between the ejecting rods 50 in the plane of the X-axis and the Y-axis.

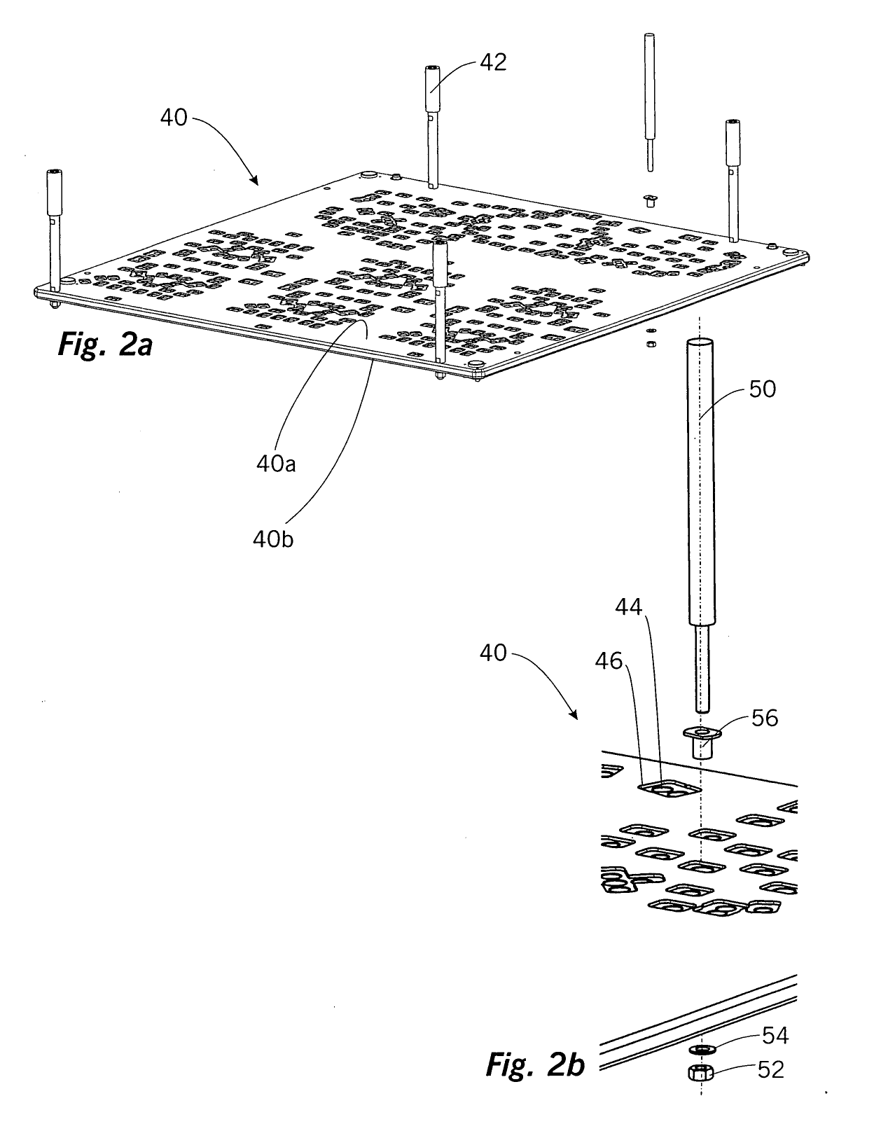

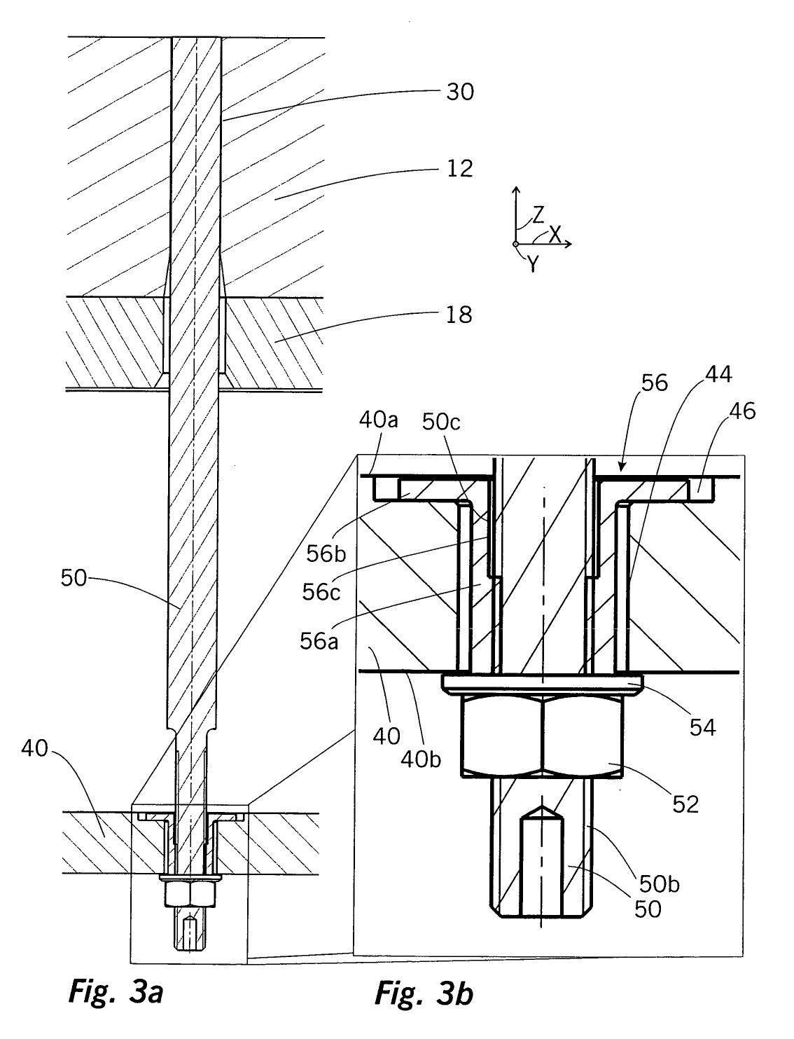

The means for attaching the ejecting rods 50 to the ejector plate 40 are described below with reference to FIGS. 2a and 2b and also with reference to FIGS. 3a and 3b. FIG. 2a is a perspective view of the ejector plate 40. In corner zones of the ejector plate 40 there are provided guide elements 42, by means of which the ejector plate 40 is guided in the direction of the Z-axis relatively to the bottom mold element 12. As is shown in FIG. 2b, a plurality of through bores 44 is provided in the ejector plate 40 for accommodating the ejecting rods 50. Furthermore, in the vicinity of each of these bores 44 there is provided a depression 46 having an approximately rectangular shape on the top surface 40a of the ejector plate 40. The depressions 46 of various bores in some cases merge with each other, so that in some cases a common depression 46, the shape of which is not necessarily rectangular, pertains to a plurality of bores 44.

For the purpose of attaching the ejecting rod 50 to the ejector plate 40, there are provided a first nut 52, a washer 54, and a flange nut 56. As can be seen from the view shown in FIG. 2b, the ejecting rod 50 itself as well as the second nut 56 configured as a flange nut for securing the ejecting rod 50 are introduced from the top surface 40a of the ejector plate 40, whereas the washer 54 and the first nut 52 are introduced from the underside 40b of the ejector plate 40.

As can be seen from FIGS. 3a and 3b, the second nut 56 is inserted from above into the depression 46 and the bore 44 in such a way that a sleeve-like wall 56a provided on the second nut 56 extends to the opposing underside 40b of the ejector plate 40 and projects slightly beyond said underside 40b. In terms of their diameters, the bore 44 and the second nut 56 are configured in such a way that a flange zone 56b of the second nut 56 does not fit through the bore 44, whereas the sleeve-like wall 56a has a distinctly smaller diameter than the bore 44 and is hence displaceable by a few millimeters in the direction of the X-axis and the Y-axis inside the bore. Similarly, the flange zone 56b of the second nut 56 is also slightly displaceable in the direction of the X-axis and the Y-axis within the depression 46.

The ejecting rod 50 is screwed by means of a second thread 50c into the female thread 56c of the second nut 56. It passes through the second nut 56 and extends to the underside 40b of the ejector plate 40 facing away from the mold element 12, where the washer 54 is positioned on the bottom end of the ejecting rod 50 and secured by means of the first nut 52 screwed onto a first thread 50b on the bottom end of the ejecting rod 50. The first nut 52 is indirectly countered by means of the washer 54 against the wall 56a of the second nut 56, thus fixing the position of the first nut 52 and the second nut 56 relatively to the ejecting rod 50 in the direction of the Z-axis. The washer 54 has a diameter that is larger than the diameter of the bore 44, thus securing the ejecting rod from being pulled upwardly and out of the ejector plate 40 in the direction of the Z-axis.

The illustrated construction of the means for attaching the ejecting rod 50 to the ejector plate 40 ensures secure attachment of the ejecting rod 50 in the direction of the Z-axis while maintaining the restricted displaceability thereof in the direction of the X-axis and the Y-axis, this being achieved by the fact that the nuts 52, 56 are countered against each other and do not exert a clamping effect on the ejector plate 40.

A particularly advantageous feature of the construction of the means for attaching the ejecting rod 50 to the ejector plate 40 is that the ejecting rod 50 can be readily replaced by another ejecting rod 50 in the event of, for example, a fracture or other signs of wear.

To this end, the nut 52 accessible from below is first unscrewed from the ejecting rod 50, and consequently the washer 54 is also loosed. Next, the ejecting rod 50 is unscrewed from the thread 56c of the second nut 56, the required torque being preferably applied to the ejecting rod 50 on that portion of said ejecting rod 50 which protrudes into the mold recess 14b. While it is being manually unscrewed, for example, the ejecting rod 50 is gently pressed down toward the ejector plate 40, in order to keep the second nut 56 in the depression 46 and thus to secure it from entrained rotation. Once the ejecting rod 50 has become unscrewed from the thread 56c of the second nut 56, it can be pulled upwardly and out through its allocated bore 30 in the mold element 12.

A new ejecting rod will then be installed, this being accomplished by first inserting the new ejecting rod through the bore 30 toward the ejector plate 40 and screwing it there into the second nut 56, which is still secured against entrained rotation, until the target position of the ejecting rod in the direction of the Z-axis is attained. Next, the washer 54 is positioned on the bottom end of the new ejecting rod projecting through the ejector plate 40, and the fully secured condition of the ejecting rod in the direction of the Z-axis is established by means of the first nut 52.

It can be seen that, with the present configuration of the casting tool, changing an ejecting rod 50 can be achieved without there being any need for manipulation in the zone 70 between the ejector plate 40 and the mold element 12.

1. A casting tool for the production of castings, in particular a sand casting tool, comprising
a mold element having a mold recess, which at least partly defines the contour of the casting to be produced,
an ejector holding device which is movable in the direction of a Z-axis relatively to said mold element and is disposed on the that side of the mold element which faces away from said mold recess, and
at least one ejector rod, which is attached to said ejector holding device and is capable of being inserted through an access bore in the mold element, oriented in the direction of the Z-axis, so as to protrude into said mold recess for the purpose of pushing out the finished casting from said mold recess,
wherein the attachment of said ejecting rod to said ejector holding device is effected in such a manner that said ejector rod has restricted freedom of movement relatively to said ejector holding device in the direction of an X-axis and/or in the direction of a Y-axis, which axes are orthogonal to each other and to the Z-axis,
characterized in that
for the purpose of attaching said ejector rod to said ejector holding device
said ejector rod passes through a connection bore in the ejector holding device and at that region of said ejector rod which is disposed on the freely accessible side of the ejector holding device remote from said mold element, a first securing element is releasably connected to said ejector rod to prevent said ejector rod from being pulled out of said ejector holding device toward said mold element.

2. The casting tool as defined in claim 1,
characterized in that
said first securing element has a first nut, which is screwed onto a thread provided on that end of said ejecting rod which is remote from said mold element.

3. The casting tool as defined in claim 1,
characterized in that
there is provided, on the side of said ejector holding device facing said mold element, a second securing element which is attached to said ejector rod and which prevents said ejector rod from being pulled out of said ejector holding device away from said mold element.

4. The casting tool as defined in claim 3,
characterized in that
said second securing element comprises a second nut, which is screwed onto said ejecting rod.

5. The casting tool as defined in claim 3,
characterized in that
the first nut is counter locked against said second securing element, and said first nut is disposed, in the locked state, such that no clamping effect on said ejector holding device is produced in the direction of the Z-axis.

6. The casting tool as defined in claim 1,
characterized in that
the first nut is counter locked against a stop member on said ejection rod, and said first nut is disposed, in the locked state, such that no clamping effect on said ejector holding device is produced in the direction of the Z-axis.

7. The casting tool as defined in claim 1 or as defined in the preamble of claim 1,
characterized by
a rotary locking part non-rotatably mounted on said ejecting rod,
wherein
said rotary locking part is disposed in an accommodating area which is in a fixed location relative to said ejector holding device and which interacts with said rotary locking part in such a manner that a complete turn of said rotary locking part about the Z-axis is blocked, and
said accommodating area is in the form of a depression formed in said ejector holding device.

8. The casting tool as defined in claim 1,
characterized in that
said connection bore has a diameter which is adapted to said ejector rod and/or a securing element such that said ejector rod can be moved in the direction of the X-axis and/or the direction of the Y-axis by at least 2 mm in either direction.

9. The casting tool as defined in claim 1,
characterized in that
said ejecting rod has, at least in a region thereof located, during intended operation, in said access bore and within said mold recess, a constant cross-section or a cross-section which tapers toward its distal end.

10. The casting tool as defined in claim 1,
characterized in that
a plurality of ejector rods is provided, said ejector rods being attached to a common ejector holding device, the number of ejector rods being preferably greater than 10, more preferably greater than 50 and most preferably greater than 100.
